(19) United States
(12) Patent Application Publication
(10) Pub. No.: US 2012/0095947 A1
(43) Pub. Date: Apr. 19, 2012

(54) VECTOR CLASSIFIER AND VECTOR CLASSIFICATION METHOD THEREOF

(75) Inventors: Sanghun Yoon, Daejeon (KR); Chun-Gi Lyuh, Daejeon (KR); Ik Jae Chun, Daejeon (KR); Jung Hee Suk, Daejeon (KR); Tae Moon Roh, Daejeon (KR)

(73) Assignee: Electronics and Telecommunications Research Institute, Daejeon (KR)

(21) Appl. No.: 13/189,345

(22) Filed: Jul. 22, 2011

(30) Foreign Application Priority Data
Oct. 18, 2010 (KR) 10-2010-0101509

(51) Int. Cl. G06N 5/02

(52) U.S. Cl. 706/46

(57) ABSTRACT

Provided is a vector classifier and a vector classification method. The vector classifier includes a vector compressor configured to compress an input vector; a support vector storage unit configured to store a compressed support vector; and a support vector machine operation unit configured to receive the compressed input vector and the compressed support vector and perform an arithmetic operation according to a classification determining equation.

### CROSS-REFERENCE TO RELATED APPLICATIONS

This U.S. non-provisional patent application claims priority under 35 U.S.C. §119 of Korean Patent Application No. 10-2010-0101509, filed on Oct. 18, 2010, the entire contents of which are hereby incorporated by reference.

### BACKGROUND OF THE INVENTION

The present invention disclosed herein relates to a vector classifier and a vector classification method thereof.

A Support Vector Machine (SVM) proposed by Vapnik in 1976 is related to a method for classifying objects which have basically two classes. When N number of objects with two classes are positioned in a P-dimensional space, in the case of classification with one hyperplane, there may exist multitudinous hyperplanes between the two classes; however, there exists a hyperplane including objects which maintain a boundary of each class in the SVM, and a hyperplane having a maximum margin is selected, wherein the margin is a s distance between the two hyperplances and the hyperplane dividing the two classes. In the case that there does not exist a hyperplane which correctly classifies the two classes, a hyperplane allowing an error may be selected. Or, the objects may be mapped to an arbitrary dimension using a kernel function suitable to an individual application, and then, a hyperplane classified in the dimension may be obtained to classify the two classes.

### SUMMARY OF THE INVENTION

The present invention provides a vector classifier capable of performing a vector classification operation with small operations and a vector classification method of the same.

Embodiments of the present invention provide vector classifiers including a vector compressor configured to compress an input vector; a support vector storage unit configured to store a compressed support vector; and a support vector machine operation unit configured to receive the compressed input vector and the compressed support vector and perform an arithmetic operation according to a classification determining equation.

In some embodiments, the classification determining equation may satisfy

$$f ( u ) = sign ( {\sum }_{i = 1}^{M} {α}_{i} {y}_{i} K ( u , {v}_{i} ) + b )$$

where M is the number of used compressed support vectors, αᵢ is a weight of an ith compressed support vector, yᵢ is a class (1/−1), vᵢ is an ith compressed support vector, b is a bias, K(u,v) is a classification kernel function, and u is the compressed input vector.

In other embodiments, the classification kernel function may be linear, polynomial, or nonlinear Radial Basis Function (RBF).

In still other embodiments, the vector compressor may compress the input vector for reducing influences of the support vector.

In even other embodiments, for compressing the input vector,

$$\begin{matrix}‖ {X}_{s} - X ‖ = ‖ {U}_{s} {D}_{s} {V}_{s}^{T} - {XV}_{s} {V}_{s}^{T} ‖ \\ = ‖ ( {U}_{s} {D}_{s} - {XV}_{s} ) {V}_{s}^{T} ‖ \\ = ‖ ( {U}_{s} {D}_{s} - {XV}_{s} ) ‖ \\ \approx ‖ ( {U}_{s} {D}_{s} ( \text{:} , 1 \text{:} P ) - {XV}_{s} ( \text{:} 1 , \text{:} P ) ) ‖\end{matrix} may be satisfied$$

where X is the input vector, Xₛ=[X_{s,1}^{T}, X_{s,2}^{T}, . . . , X_{s,M}^{T}]^{T}=UₛDₛVₛ^{T}, X_{s,M} is an Mth support vector, Uₛ and Vₛ are orthogonal and unitary matrix, and

$${D}_{s} = [ \begin{matrix}{λ}_{1} & 0 & … & 0 & 0 \\ 0 & {λ}_{2} & … & 0 & 0 \\ ⋮ & ⋮ & ⋱ & ⋮ & ⋮ \\ 0 & 0 & … & {λ}_{n - 1} & 0 \\ 0 & 0 & … & 0 & {λ}_{n}\end{matrix} ] , {λ}_{i} \geq {λ}_{i + 1}$$

where the first ‘:’ in (:,1:P) expresses that elements of all rows are included and ‘1:P’ expresses that only first P number of elements of all columns are selected.

In yet other embodiments, the compressed input vector is XVₛ(:,1:P), and the compressed support vector is UₛDₛ(:,1:P).

In further embodiments, the support vector storage unit may include a storage space as much as a value of multiplying a degree of the input vector by a degree of the compressed input vector and a storage space as much as a value of multiplying a degree of multiplying the compressed support vector by the degree of the compressed input vector.

In still further embodiments, the support vector machine operation unit may include a kernel calculator configured to receive the compressed input vector and the compressed support vector and calculate a kernel value according to a predetermined classification kernel function; a multiplier configured to multiply a weight which corresponds to the calculated kernel value by the kernel value; a register configured to accumulate output values of the multiplier; and a filter configured to generate a classification value from the accumulated value of the register using a sign function.

In even further embodiments, the vector classifier may further include a support vector machine trainer configured to output the compressed support vector.

In yet further embodiments, the support vector machine trainer may include a training vector storage unit configured to store training vectors; a training vector compression unit configured to compress a training vector outputted from the training vector storage unit; and a vector training unit configured to select a support vector using the compressed training vector.

In other embodiments of the present invention, vector classification methods of a vector classifier include compressing an input vector for reducing a degree of the input vector; and classifying according to a classification determining equation receiving the compressed input vector and a compressed support vector.

In some embodiments, the vector classification method may further include compressing a support vector.

In other embodiments, the compressing the support vector may include compressing a training vector and selecting a support vector using the compressed training vector.

In still other embodiments, the selected support vector may be the compressed support vector.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating a vector classifier 100 according to the embodiment of the present invention;

FIG. 2 is a diagram illustrating a structure of a support vector storage unit illustrated in FIG. 1;

FIG. 3 is a diagram illustrating a support vector machine operation unit illustrated in FIG. 1 in detail;

FIG. 4 is a flowchart illustrating a vector classification method of the vector classifier according to the present invention;

FIG. 5 is a block diagram illustrating a support vector machine trainer according to the embodiment of the present invention;

FIG. 6 is a diagram illustrating a degree of precision of the vector classifier according to the present invention; and

FIG. 7 is a table illustrating hardware resources and precision degree during compression of the input vector according to the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

For a better understanding of the present invention, several numerical expressions relating to a Support Vector Machine (SVM) will be described.

The SVM is applied to regression, classification, and density estimation problem with a principal of Structural Risk Minimization (SRM) from a statistical training theory. The SVM performs a binary classification (i.e., 2 output classes) detecting a determining hypersurface which splits a positive sample from a negative sample in a feature space of the SVM, wherein the determining hypersurface is included in a category of a maximum margin classifier.

Although the SVM is fixed for explaining a training task, the SVM receives a training sample S=(x₁, y₁), (x₂, y₂), . . . , (xₙ, yₙ) which is independent and equally distributed having a size of n from an undisclosed distribution Pr(x, y). Herein, xᵢ denotes a vector showing classified input data and yᵢ denotes a class in a set {−1, +1}.

The SVM trains a binary linear determination rule according to a following equation.

$$h ( x ) = \{ \begin{matrix}sign ( w \cdot x + b ) , & w \cdot x + b \geq 0 \\ - 1 , & elsewhere\end{matrix}$$

Herein, a determination function is expressed by a weight vector ‘w’ and a threshold value ‘b’. According to an aspect of a hypersurface where the input vector ‘x’ lies, it is classified into a class ‘+1’ or ‘−1’. According to a concept of the SRM, a hypothesis ‘h’ guaranteeing a lowest error probability is searched. This may be interpreted as finding a hypersurface which has a largest margin for a target-separable data with the SVM. In other words, for a separable training set, the SVM finds the hypersurface ‘h’ which separates positive and negative training samples marked with ‘+’ and ‘−’ respectively with a largest margin. A nearest sample to the hypersurface ‘h’ is called a support vector.

Calculating the hypersurface is the same as solving a secondary optimization problem in a following equation in a Lagrangian expression.

$$W ( α ) = - {\sum }_{i = 1}^{n} {α}_{i} + \frac{1}{2} {\sum }_{i = 1}^{n} {\sum }_{j = 1}^{n} {y}_{i} {y}_{j} {α}_{i} {α}_{j} {x}_{i} {x}_{j}$$

$$\sum {α}_{i} {y}_{i} = 0 , ∀ {α}_{i} , 0 \leq {α}_{i} \leq C , i = 1 , … , n$$

The support vector is a training vector xᵢ corresponding to a positive Lagrangian coefficient of αᵢ>0. Solving this optimization problem, the determination rule may be calculated with a following equation.

w·x=Σαᵢyᵢxᵢx and b=yₜₛᵥ−w·xₜₛᵥ

where a training sample (xₜₛᵥ, yₜₛᵥ) for calculating ‘b’ is a support vector satisfying αₜₛᵥ<C

Not only for applying the trained determination rule but also for solving the secondary optimization problem, an inner product between observation vectors. Using these characteristics, use of a kernel function expressed by K(x₁, x₂) is introduced to training a nonlinear determination rule. The kernel function calculates an inner product in several high-dimensional feature spaces and replaces the inner product with a following equation.

Generally, the kernel function may be linear, polynomial, Radial Basis Function (RBF), and sigmoid.

Kₗᵢₙ(xᵢ,xⱼ)=xᵢ·xⱼ

K_{poly}(xᵢ,xⱼ)=(xᵢ,xⱼ+1)^{p}

K_{rbf}(xᵢ,xⱼ)=exp(−(xᵢ−xⱼ)²/s²)

K_{sig}(xᵢ,xⱼ)=tan h(s(xᵢ·xⱼ)+c)

According to a type of the kernel function, the SVM may be a linear classifier, a polynomial classifier, an RBF classifier, or a double-layered sigmoid nerve network. Hereinafter, it is assumed that the kernel function is the RBF for convenience.

The vector classifier according to the embodiment of the present invention may perform the vector classification with fewer operations by compressing an input vector in comparison with a typical vector classifier. Therefore, the vector classifier according to the present invention may classifies vectors in real time.

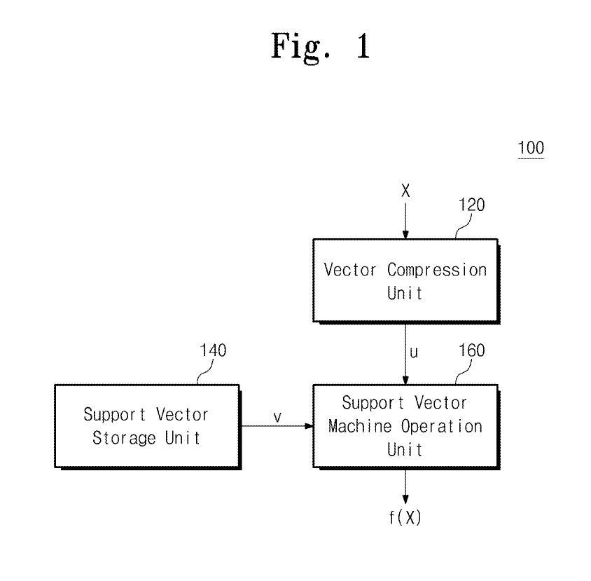

FIG. 1 is a block diagram illustrating a vector classifier 100 according to the embodiment of the present invention. Referring to FIG. 1, the vector classifier 100 includes a vector compression unit 12, a support vector storage unit 140, and a support vector machine operation unit 160.

The vector compression unit 120 compresses an input vector X using a support vector Xs. Herein, the support vector Xs is analyzed to UₛDₛVₛ^{T} through a Singular Value Decomposition (SVD). Herein, Uₛ and Vₛ are normalized to a eigenvector set. Dₛ is a diagonal matrix and its value expresses influence power of a eigenvector.

For compressing the input vector X, most influential P number of values among the eigenvector is maintained and the others are eliminated. Herein, the vector may be compressed to a state where a change of the influence power of the eigenvector is minimized. When the classification is performed using the RBF classification kernel function, an equation for compressing the input vector X is expressed as follows.

$$\begin{matrix}‖ {X}_{s} - X ‖ = ‖ {U}_{s} {D}_{s} {V}_{s}^{T} - {XV}_{s} {V}_{s}^{T} ‖ \\ = ‖ ( {U}_{s} {D}_{s} - {XV}_{s} ) {V}_{s}^{T} ‖ \\ = ‖ ( {U}_{s} {D}_{s} - {XV}_{s} ) ‖ \\ \approx ‖ ( {U}_{s} {D}_{s} ( \text{:} , 1 \text{:} P ) - {XV}_{s} ( \text{:} 1 , \text{:} P ) ) ‖\end{matrix}$$

where Xₛ=[X_{s,1}^{T},X_{s,2}^{T}, . . . , X_{s,M}T]^{T}=UₛDₛVₛ^{T}, Uₛ and Vₛ are orthogonal and unitary matrix, and

$${D}_{s} = [ \begin{matrix}{λ}_{1} & 0 & … & 0 & 0 \\ 0 & {λ}_{2} & … & 0 & 0 \\ ⋮ & ⋮ & ⋱ & ⋮ & ⋮ \\ 0 & 0 & … & {λ}_{n - 1} & 0 \\ 0 & 0 & … & 0 & {λ}_{n}\end{matrix} ] , {λ}_{i} \geq {λ}_{i + 1}$$

Meanwhile, XVₛ(:,1:P) is a compressed input vector and UₛDₛ(:,1:P) is a compressed support vector ‘v’. Herein, the first ‘:’ in (:,1:P) expresses that elements of all rows are included and ‘1:P’ expresses that only first P number of elements of all columns are selected.

The support vector storage unit 140 stores the compressed support vector ‘v’. Herein, the compressed support vector ‘v’ may be provided by a support vector machine training unit (not illustrated).

The support vector machine operation unit 160 receives the compressed input vector and the compressed support vector ‘v’ and performs an operation according to a classification determining equation. Herein, the classification determining equation may be expressed as a following equation.

$$f ( u ) = sign ( {\sum }_{i = 1}^{M} {α}_{i} {y}_{i} K ( u , {v}_{i} ) + b )$$

where M is the number of used compressed support vectors, αᵢ is a weight of an ith compressed support vector, yᵢ is a class (1/−1), vᵢ is an ith compressed support vector, b is a bias, and K(u,v) is a classification kernel function. Herein, the classification kernel function is linear or nonlinear.

In the embodiment, if the classification kernel function is a nonlinear Radial Basis Function (RBF), K(u,v) satisfies a following equation.

K(u,v)=exp(−r∥u−v∥²)

where γ is a coefficient of the RBF classification kernel function.

The vector classifier 100 according to the embodiment of the present invention compresses the input vector X and the support vector Xs using the support vector Sx and receives the compressed input vector ‘v’ and the compressed support vector ‘u’ to perform the operation according to the classification determining equation. Accordingly, the vector classifier 100 according to the embodiment of the present invention may classify a real-time input vector X by reducing degree of the input vector X and the support vector Xs.

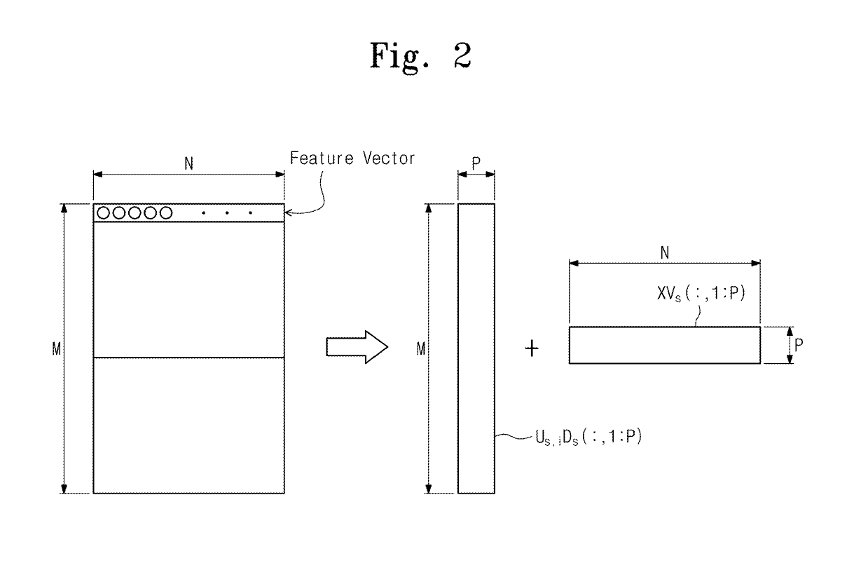

FIG. 2 is a diagram illustrating a structure of the support vector storage unit 140 illustrated in FIG. 1. Referring to FIG. 2, a storage space of the support vector storage unit 140 may be remarkably reduced in comparison with a typical support vector storage unit.

The typical support vector storage unit needs a storage space as much as a value gained by multiplying a degree N of the input vector and a degree M of the support vector M, i.e., N×M.

On the contrary, the support vector storage unit 140 of the present invention needs a storage space as much as a value gained by multiplying a compressed degree P and the degree N of the input vector, i.e., P×N, and a storage space as much as a value gained by multiplying the compressed degree P and the degree M of the support vector, i.e., P×M. Herein, P is smaller than M and N. The storage space P×N stores Vₛ and the storage space P×M stores the compressed support vector, i.e., v=U_{s,i}Dₛ(:,1:P).

In the embodiment, the classification determining equation according to the present invention may be implemented as software. In another embodiment, the classification determining equation according to the present invention may be implemented as hardware.

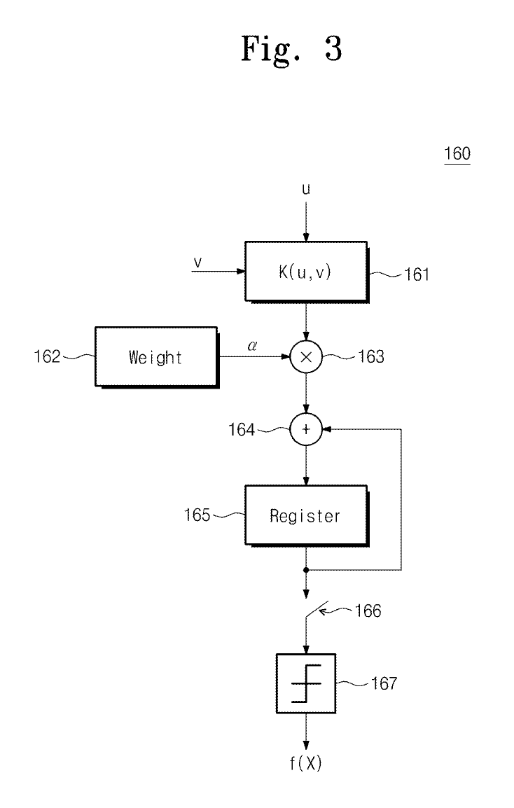

FIG. 3 is a diagram illustrating the support vector machine operation unit 160 illustrated in FIG. 1 in detail. Referring to FIG. 3, the support vector machine unit 160 includes a kernel calculator 161, a weight storage 162, a multiplier 163, an adder 164, a register 165, a switch 166, and a filter 167.

The kernel calculator 161 receives the compressed input vector ‘u’ and the compressed support vector ‘v’ and calculates a kernel value K(u, v). The kernel calculator 161 may include one of a linear classification kernel function, a polynomial classification kernel function, and an RBF classification kernel function.

The weight storage 162 stores weights corresponding to each support vector. The weight storage 162 is such implemented so as to output a weight α corresponding to the kernel value K(u, v) calculated by the kernel calculator 161.

The multiplier 163 receives the kernel value K(u, v) of the kernel calculator 161 and the weight α outputted from the weight storage 162 to perform a multiplying operation.

The adder 164 receives an output of the multiplier 163 and a value stored in the register 165 to perform an adding operation.

The register 165 accumulates outputs of the adder 164. An output value accumulated in the register 165 satisfies a following equation.

$${\sum }_{i = 1}^{M} {α}_{i} K ( u , {v}_{i} )$$

where M denotes the number of used compressed support vectors, αᵢ denotes a weight of ith compressed support vector, and vᵢ denotes an ith compressed support vector.

The switch 166 determines whether to transfer the accumulated value of the register 165 to the filter 167. For instance, when the kernel value is accumulated as much as the number of compressed support vectors, the switch 166 transfers the accumulated value of the register 165 to the filter 167.

The filter 167 filters the stored value of the register 165 and outputs a final classification value f(x). Herein, the filter 167 may use a sign function. Herein, the output value f(x) of the filter 167 is one of −1, 0, and 1.

The support vector machine operation unit 160 according to the embodiment of the present invention accumulates kernel values for the compressed input vector ‘u’ according to the classification determining equation and encodes the accumulated value using the sign function.

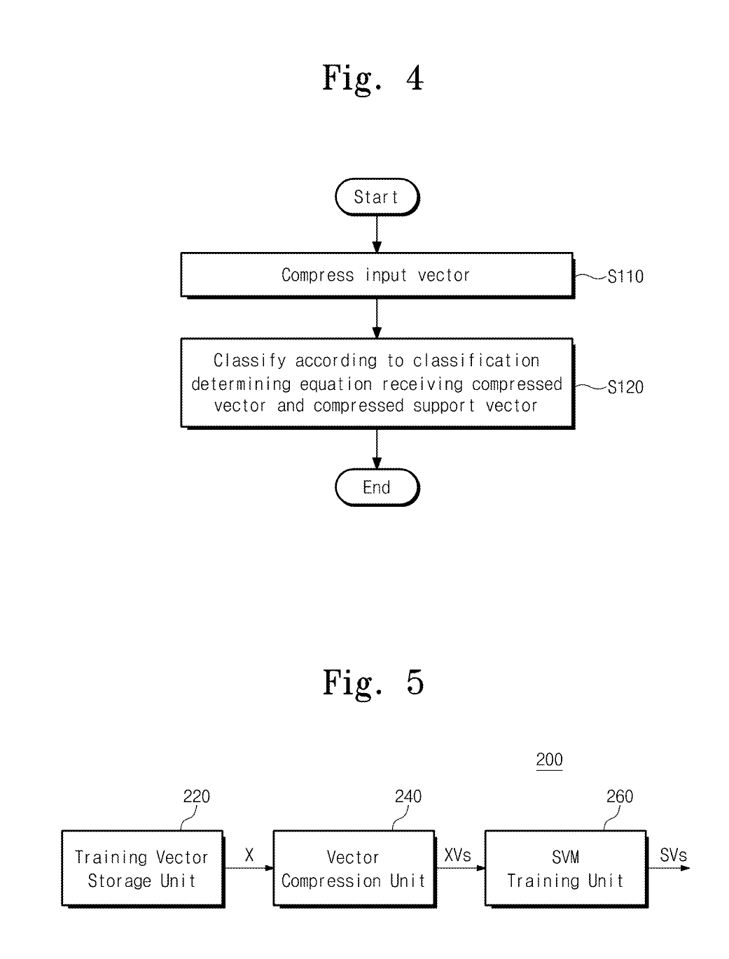

FIG. 4 is a flowchart illustrating a vector classification method of the vector classifier according to the present invention. Referring to FIG. 4, according to the vector classification method, the degree of the input vector is compressed in operation S110. In operation S120, the compressed vector and the compressed support vector are received and the classification is performed according to the previously determined classification determining equation.

In the embodiment, the operation of compressing the input vector may include the operation of reducing the degree of the input vector.

In the embodiment, operations of compressing a training vector and selecting a support vector using the compressed training vector may be further included. Herein, the selected support vector is the compressed support vector.

According to the vector classification method according to the embodiment of the present invention, the degrees of the input vector and the support vector are reduced for operation, and thus, a operation speed of the vector classifier may increased.

FIG. 5 is a block diagram illustrating a support vector machine trainer 200 according to the embodiment. Referring to FIG. 5, the support vector machine trainer 200 includes a training vector storage unit 220, a vector compression unit 240, and a vector training unit 260.

The training vector storage unit 220 stores a plurality of training vectors.

The vector compression unit 240 receives a training vector X outputted from the training vector storage unit 220 and compresses the received training vector X. Herein, a degree of the training vector X is decreased to become the compressed training vector XVs.

The vector training unit 260 receives the compressed training vector XVs from the vector compression unit 240, selects a support vector SVs, and outputs the selected support vector SVs. Herein, the selected support vector SVs may be the compressed support vector ‘v’ stored in the support vector storage unit 140 of FIG. 1.

The support vector machine trainer 200 according to the embodiment of the present invention generates the compressed support vector SVs. That is, the support vector machine trainer 200 according to the embodiment of the present invention may reduce the degree of the support vector Vs in comparison with a typical support vector machine trainer.

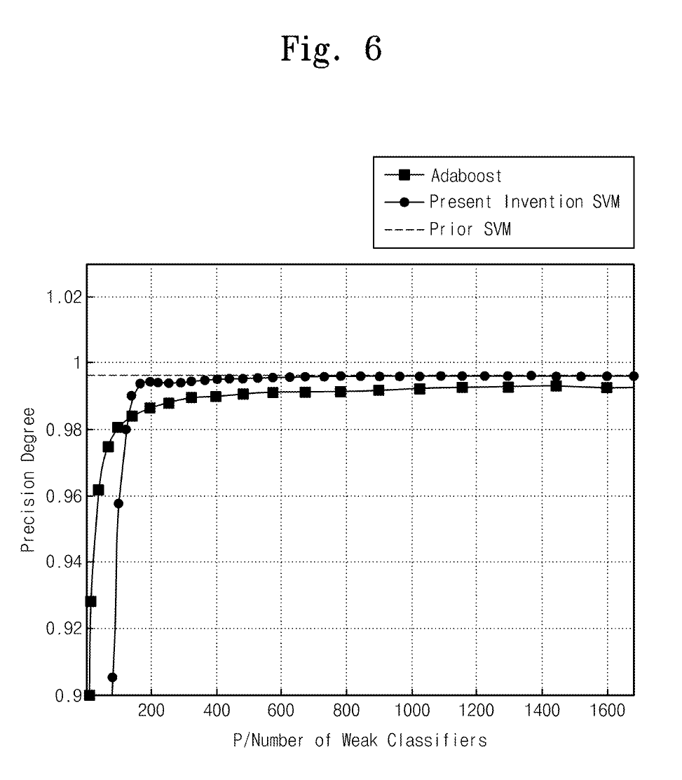

FIG. 6 is a diagram illustrating a degree of precision of the vector classifier according to the present invention. In FIG. 6, a pedestrian recognizing image, in which the degree N of the input vector X is 48 and the degree M of the support vector Vs is 96, is used as an example. When the total degree is 48×96, i.e., 1980, and the compressed degree P is larger than 180, degradation of the precision is almost nothing. Referring to FIG. 6, the degree of precision of the SVM according to the present invention is similar to that of a typical SVM. Also, the degree of precision of the SVM according to the present invention is higher than that of a classifier which adopts Adaboost. In the case of the classifier adopting the Adaboost, a horizontal axis of FIG. 6 denotes the number of weak classifiers.

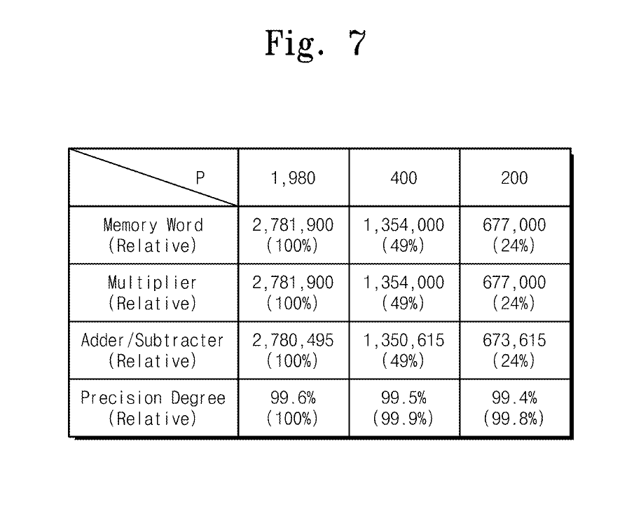

FIG. 7 is a table illustrating hardware resources and precision degree during compression of the input vector according to the present invention.

When an original input vector is used without compression, each number of needed memory words and needed multipliers is about 2,781,900 (100%), and the number of needed adders or subtracters is about 2,780,495. In this case, the precision degree is about 99.6%.

On the contrary, when the compressed degree is 400, each number of needed memory words and needed multipliers is about 1,354,000 (49%) and the number of needed adders or subtracters is about 1,350,615 (49%). That is, when the compressed degree P is 400, there is an effect of saving hardware resources by about 51%. In this case, the precision degree is about 99.5%.

Meanwhile, when the compressed degree P is 200, each number of needed memory words and needed multipliers is about 677,000 (24%) and the number of needed adders or subtracters is about 673,615 (24%). That is, when the compressed degree P is 200, there is an effect of saving hardware resources by about 76%. In this case, the precision degree is about 99.4%.

As described above, according to the vector classifier and the vector classification method according to the present invention, the degrees of the input vector and the support vector are reduced for operation, and thus, input vectors can be classified in real time.

Also, according to the vector classifier according to the present invention, since the compressed support vector is stored, a storage space of the SVM can be reduced.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A vector classifier, comprising:
a vector compressor configured to compress an input vector;
a support vector storage unit configured to store a compressed support vector; and
a support vector machine operation unit configured to receive the compressed input vector and the compressed support vector and perform an arithmetic operation according to a classification determining equation.

2. The vector classifier of claim 1, wherein the classification determining equation satisfies
$$f ( u ) = sign ( {\sum }_{i = 1}^{M} {α}_{i} {y}_{i} K ( u , {v}_{i} ) + b )$$
where M is the number of compressed support vectors, αᵢ is a weight of an ith compressed support vector, yᵢ is a class (1/−1), vᵢ is an ith compressed support vector, b is a bias, K(u,v) is a classification kernel function, and u is the compressed input vector.

3. The vector classifier of claim 2, wherein the classification kernel function is linear.

4. The vector classifier of claim 2, wherein the classification kernel function is polynomial.

5. The vector classifier of claim 2, wherein the classification kernel function is a nonlinear Radial Basis Function (RBF).

6. The vector classifier of claim 5, wherein the vector compressor compresses the input vector for reducing influences of the support vector.

7. The vector classifier of claim 6, wherein for compressing the input vector,
$$\begin{matrix}‖ {X}_{s} - X ‖ = ‖ {U}_{s} {D}_{s} {V}_{s}^{T} - {XV}_{s} {V}_{s}^{T} ‖ \\ = ‖ ( {U}_{s} {D}_{s} - {XV}_{s} ) {V}_{s}^{T} ‖ \\ = ‖ ( {U}_{s} {D}_{s} - {XV}_{s} ) ‖ \\ \approx ‖ ( {U}_{s} {D}_{s} ( \text{:} , 1 \text{:} P ) - {XV}_{s} ( \text{:} 1 , \text{:} P ) ) ‖\end{matrix} is satisfied$$
where X is the input vector, Xₛ=[X_{s,1}^{T},X_{s,2}^{T}, . . . , X_{s,M}T]^{T}=UₛDₛVₛ^{T}, X_{s,M} is an Mth support vector, Uₛ and Vₛ are orthogonal and unitary matrix, and
$${D}_{s} = [ \begin{matrix}{λ}_{1} & 0 & … & 0 & 0 \\ 0 & {λ}_{2} & … & 0 & 0 \\ ⋮ & ⋮ & ⋱ & ⋮ & ⋮ \\ 0 & 0 & … & {λ}_{n - 1} & 0 \\ 0 & 0 & … & 0 & {λ}_{n}\end{matrix} ] , {λ}_{i} \geq {λ}_{i + 1}$$
where the first ‘:’ in (:,1:P) expresses that elements of all rows are included and ‘1:P’ expresses that only first P number of elements of all columns are selected.

8. The vector classifier of claim 7, wherein the compressed input vector is XVₛ(:,1:P), and the compressed support vector is UₛDₛ(:,1:P).

9. The vector classifier of claim 7, wherein the support vector storage unit comprises a storage space as much as a value of multiplying a degree of the input vector by a degree of the compressed input vector and a storage space as much as a value of multiplying a degree of multiplying the compressed support vector by the degree of the compressed input vector.

10. The vector classifier of claim 1, wherein the support vector machine operation unit comprises:
a kernel calculator configured to receive the compressed input vector and the compressed support vector and calculate a kernel value according to a predetermined classification kernel function;
a multiplier configured to multiply a weight which corresponds to the calculated kernel value by the kernel value;
a register configured to accumulate output values of the multiplier; and
a filter configured to generate a classification value from the accumulated value of the register using a sign function.

11. The vector classifier of claim 1, further comprising a support vector machine trainer configured to output the compressed support vector.

12. The vector classifier of claim 11, wherein the support vector machine trainer comprises:
a training vector storage unit configured to store training vectors;
a training vector compression unit configured to compress a training vector outputted from the training vector storage unit; and
a vector training unit configured to select a support vector using the compressed training vector.

13. A vector classification method of a vector classifier, comprising:
compressing an input vector for reducing a degree of the input vector; and
classifying according to a classification determining equation receiving the compressed input vector and a compressed support vector.

14. The vector classification method of claim 13, further comprising compressing a support vector.

15. The vector classification method of claim 13, wherein the compressing the support vector comprises compressing a training vector and selecting a support vector using the compressed training vector.

16. The vector classification method of claim 15, wherein the selected support vector is the compressed support vector.
